(19) United States
(12) Patent Application Publication
(10) Pub. No.: US 2015/0269851 A1
(43) Pub. Date: Sep. 24, 2015

(54) MOBILE BASED EXERCISE AND REHABILITATION PRESCRIPTION TOOL AND APPLICATION

(71) Applicant: RMG, INC., Florence, SC (US)

(72) Inventors: Mark Wayne LEE, Florence, SC (US); Michael SLONIEWSKY, Florence, SC (US)

(21) Appl. No.: 14/661,655

(22) Filed: Mar. 18, 2015

Related U.S. Application Data
(60) Provisional application No. 61/969,010, filed on Mar. 21, 2014.

(51) Int. Cl. G09B 5/02

(52) U.S. Cl. CPC G09B 5/02

(57) ABSTRACT

Embodiments generally relate to methods of visual delivery of prehab and rehabilitation. Embodiments generally include the use a remote device to receive visual instruction for prehab and rehabilitation. The visual instruction can be create during the interaction between the patient and the skilled provider. The visual instruction is created, modified or utilized by the patient under the direction of a skilled provider. Further, the visual instruction is modified based on feedback from the patient.

### BACKGROUND

1. Field

Embodiments of the present invention generally relate to joint rehabilitation. More specifically, embodiments generally relate to methods of delivering joint rehabilitation to a patient.

2. Description of the Related Art

Osteoarthritis (OA) is among the most common causes of musculoskeletal pain and disability in the United States. Since there is no cure for OA at present, the primary aims of treatment are to reduce pain, maintain or improve function and mobility, and prevent or slow the progression of adverse changes to the joint tissues, while keeping potential therapeutic toxicities to a minimum. Current treatment guidelines begin with non-pharmacologic protocols, such as patient education, weight loss, and physical therapy or rehabilitation.

Persons often need a prolonged rehabilitation process in an attempt to recapture some or all of the body functions due to OA related degeneration. Such rehabilitation may include one or both of two elements, a physical rehabilitation portion, in which damaged or unused muscles, nerves and/or joints are brought back to full functioning (to the extent possible) and a cognitive rehabilitation portion, in which the cognitive ability to control the body is restored. In some cases, the damage to the body and/or brain is such that a patient needs to be trained in modified functionality (e.g., loss of joint mobility due to degeneration) or even new functionality, for example, related to the use of a synthetic knee.

Physical therapy is currently provided mainly by personal attention of a physical therapist or other provider who monitors and instructs a patient in the performance of certain exercises. Thus, costs for rehabilitation are high and compliance after a patient leaves a treatment center is relatively low.

As such, there is a need in the art for more cost-effective methods of rehabilitation delivery for joint preparation and restoration. Further, there is a need in the art for better control of patient compliance outside of the provider setting.

### SUMMARY

Embodiments of the present invention generally relate to methods for mobile rehabilitation delivery. In one embodiment, a method of rehabilitation can include determining that a patient has an indicator of osteoarthritis in a joint; creating a prehab protocol comprising one or more activities to prepare the patient for rehabilitation; delivering a visual prehab system to the patient; repeating the visual prehab system until the patient has reached a modified health state; and providing a rehabilitation protocol to the patient at the modified health state, the rehabilitation regimen comprising one or more activities established for rehabilitation of the patient. The visual prehab system can include creating a visual prehab regimen based on the prehab protocol, the visual prehab regimen comprising one or more recorded visual representations of the prehab protocol; delivering the visual prehab regimen to a remote device, the patient performing one or more activities based on the visual prehab regimen; eliciting input from the patient regarding the visual prehab regimen, the patient providing said input; and adjusting the visual prehab regimen and the prehab protocol based on input from the patient.

In another embodiment, a method of rehabilitation can include creating a rehabilitation protocol for a patient having osteoarthritis in a joint, the rehabilitation protocol comprising one or more activities established for rehabilitation of the patient by a trained provider; creating a visual rehabilitation regimen based on the rehabilitation protocol, the visual rehabilitation regimen comprising one or more recorded visual representations of the rehabilitation protocol; delivering the visual rehabilitation regimen to a remote device, the patient performing the one or more activities based on the visual rehabilitation regimen; eliciting input from the patient regarding the visual rehabilitation regimen, the patient providing said input; adjusting the rehabilitation protocol and the visual rehabilitation regimen using input from the patient; delivering an adjusted visual rehabilitation regimen based on the adjusted rehabilitation protocol to the remote device, the patient performing one or more second activities based on the adjusted visual rehabilitation regimen; monitoring the patient during the performance of the rehabilitation protocol and the adjusted rehabilitation protocol for a replacement indicator; and upon detecting a replacement indicator, delivering a prehab regimen, the prehab regimen comprising one or more activities to prepare the patient for replacement of a joint.

In another embodiment, a method of rehabilitation can include delivering a prehab protocol, the prehab protocol comprising one or more activities to prepare the patient for a replacement of a joint; replacing the joint of the patient; creating a rehabilitation protocol for a patient after the joint is replaced, the rehabilitation protocol comprising one or more activities established for rehabilitation of the patient; creating a live action video based on the rehabilitation protocol, the live action video comprising one or more recorded visual representations of the rehabilitation protocol; delivering the live action video to a remote device, the patient performing the one or more activities based on the live action video; eliciting input from the patient regarding the activities performed by the patient in conjunction with the live action video, the patient providing said input; adjusting the rehabilitation protocol using input from the patient; and delivering an adjusted live action video to the remote device, the patient performing one or more second activities based on the adjusted live action video.

In another embodiment, a method of rehabilitation can include creating a prehab protocol comprising one or more activities to prepare a patient for rehabilitation; delivering a visual prehab system to the patient; repeating the visual prehab system until the patient has reached a modified health state; and providing a rehabilitation protocol to the patient at the modified health state, the rehabilitation protocol comprising one or more activities established for rehabilitation of the patient. The visual prehab system can include creating a visual prehab regimen based on the prehab protocol, the visual prehab regimen comprising one or more recorded visual representations of the prehab protocol; delivering the visual prehab regimen to a remote device, the visual prehab regimen instructing the patient to perform one or more activities based on the visual prehab regimen; receiving input from the patient regarding the visual prehab regimen; and adjusting the visual prehab regimen and the prehab protocol based on input from the patient;

In another embodiment, a method of rehabilitation can include creating a rehabilitation protocol for a patient having osteoarthritis in a joint, the rehabilitation protocol comprising one or more activities established for rehabilitation of the patient by a skilled provider; creating a visual rehabilitation regimen based on the rehabilitation protocol, the visual rehabilitation regimen comprising one or more recorded visual representations of the rehabilitation protocol; delivering the visual rehabilitation regimen to a remote device, the visual rehabilitation regimen instructing the patient to perform the one or more activities based on the visual rehabilitation regimen; receiving input from the patient regarding the visual rehabilitation regimen; adjusting the rehabilitation protocol and the visual rehabilitation regimen using input from the patient; delivering an adjusted visual rehabilitation regimen based on the adjusted rehabilitation protocol to the remote device, the adjusted rehabilitation regimen instructing the patient to perform one or more second activities based on the adjusted visual rehabilitation regimen; monitoring the patient during the performance of the rehabilitation protocol and the adjusted rehabilitation protocol for a replacement indicator; and upon detecting a replacement indicator, delivering a prehab regimen, the prehab regimen comprising one or more activities to prepare the patient for replacement of a joint.

In another embodiment, a method of rehabilitation can include delivering a prehab protocol, the prehab protocol comprising one or more activities to prepare the patient for a replacement of a joint; replacing the joint of the patient; creating a rehabilitation protocol for a patient after the joint is replaced, the rehabilitation protocol comprising one or more activities established for rehabilitation of the patient; creating a live action video based on the rehabilitation protocol, the live action video comprising one or more recorded visual representations of the rehabilitation protocol; delivering the live action video to a remote device, the live action video instructing the patient to perform the one or more activities; receiving input from the patient regarding the activities performed in conjunction with the live action video; adjusting the rehabilitation protocol using input from the patient; and delivering an adjusted live action video to the remote device, the patient performing one or more second activities based on the adjusted live action video.

In another embodiment, a method of rehabilitation can include receiving a prehab protocol comprising one or more activities to prepare for rehabilitation; receiving a visual prehab system, repeating the visual prehab system until reaching a modified health state; and performing a rehabilitation protocol at the modified health state, the rehabilitation protocol comprising one or more activities established for rehabilitation. The visual prehab system can include receiving a visual prehab regimen based on the prehab protocol, the visual prehab regimen comprising one or more recorded visual representations of the prehab protocol; performing one or more activities based on the visual prehab regimen, the visual prehab regimen being received by a remote device, the visual prehab regimen providing instructions to perform one or more activities based on the visual prehab regimen; sending input to the skilled provider regarding the visual prehab regimen; and receiving from the skilled provider adjustments to the visual prehab regimen and the prehab protocol based on the input sent to the provider;

In another embodiment, a method of rehabilitation can include receiving a rehabilitation protocol for osteoarthritis in a joint, the rehabilitation protocol comprising one or more activities established for rehabilitation by a skilled provider; receiving a visual rehabilitation regimen using a remote device, the visual rehabilitation regimen being based on the rehabilitation protocol and comprising one or more recorded visual representations of the rehabilitation protocol; performing the one or more activities based on the visual rehabilitation regimen; providing input to the skilled provider regarding the visual rehabilitation regimen; and receiving an adjusted visual rehabilitation regimen based on the adjusted rehabilitation protocol to the remote device, the adjusted rehabilitation regimen having instructions to perform one or more second activities based on the adjusted visual rehabilitation regimen.

In another embodiment, a method of delivery of physical development packages can include a provider determining one or more post recovery needs in an end user; creating a physical development protocol comprising one or more activities to address the post recovery need; creating a physical development package based on the physical development protocol, the physical development package comprising one or more recorded visual representations of the physical development protocol; and providing the physical development package to a remote device through an e-commerce system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram of a method of rehabilitation which can be incorporated with one or more embodiments described herein;

FIG. 2 depicts a visual treatment system, according to one embodiment;

FIG. 3 is a flow diagram of a method of visual rehabilitation, according to one embodiment; and

FIG. 4 is a flow diagram of a method of visual prehab, according to one embodiment.

FIG. 5 is a flow diagram of a method of delivery of physical development packages, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein generally relate to delivery of joint rehabilitation using one or more video delivery systems. The video delivery system can be a networked device, such as a computer or a smartphone. The patient will receive visual instruction through the video delivery system. The visual instruction relates to a prehab regimen or a rehabilitation regimen received from a clinician. Prehab is one or more physical activities designed for the patient to prepare a patient for either rehabilitation or a surgical procedure. Rehabilitation is one or more physical activities designed for the patient to increase mobility or other physical attributes of the patient. The goal of prehab is largely to prevent injury during a subsequent procedure or activity. The goal of rehabilitation is to recover from an injury or degeneration.

The visual instruction can be either recorded with the patient or recorded using one or more actors. The visual instruction, either for prehab or rehabilitation, can include current information, expected future information and situational future information. The current information includes information related to treatment based on the current status of the patient. The expected future information includes information related to expected development of the patient following a designed prehab or rehabilitation regimen. Situational future information includes information related to possible issues or developments in the patient as a result of or related to the designed prehab or rehabilitation regimen.

As the patient performs the prehab or rehabilitation regimens, the patient will receive periodic prompts for feedback. The feedback received from the patient can then be used to modify the visual instruction received through the video. The modified information can come from a video library, secondary visual instruction produced using patient/clinician interaction or by a live action feed. The methods and systems described here can reduce costs, increase patient compliance and provide better outcomes as compared to standard rehabilitation. The invention disclosed herein can be more clearly understood with reference to the figures described below which illustrate embodiments of the invention.

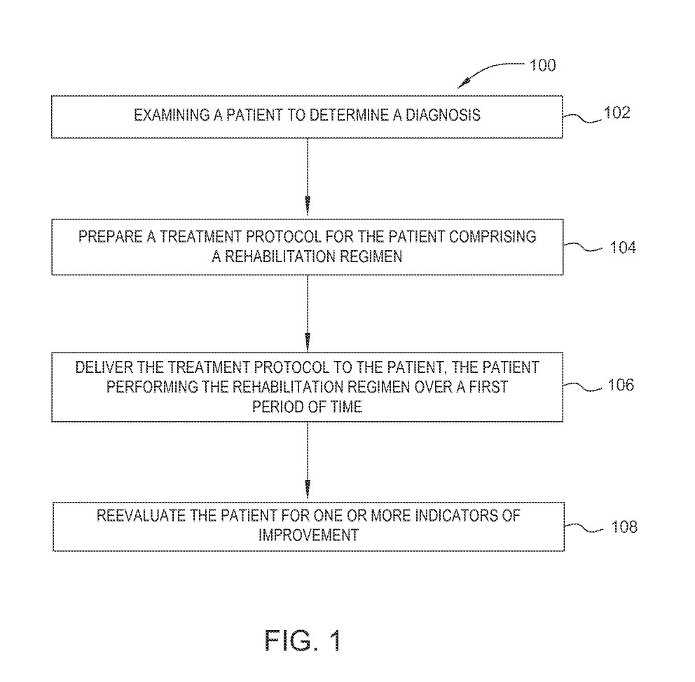

FIG. 1 depicts a rehabilitation method 100. The method 100 includes examining a patient to determine a diagnosis, at 102; preparing a treatment protocol for the patient comprising a rehabilitation regimen, at 104; delivering the treatment protocol to the patient, at 106; and reevaluating the patient for one or more indicators of improvement, at 108. One or more elements of the method described here can be beneficially incorporated into embodiments as described herein. A method for rehabilitation describing the delivery of a treatment protocol is described in greater detail in U.S. patent application Ser. No. 13/958,292, entitled “COMBINATORIAL THERAPY FOR TREATMENT OF OSTEOARTHRITIS OF THE KNEE” and filed Aug. 2, 2013, and is incorporated by reference herein.

The method 100 begins with examining a patient to determine a diagnosis, at 102. Generally, a patient has some physiological indication of a joint related issue, such as joint mobility reduction or pain in a joint. The patient then visits with a skilled provider. The skilled provider can be a medical doctor, a physical therapist, or other health care provider trained in joint treatment and rehabilitation. The skilled provider visits with the patient and examines the site of the pain to determine a diagnosis, such as a diagnosis of osteoarthritis. The examination can include both a visual examination and examination using specialized equipment, such as a fluoroscope, an ultrasound device or other equipment.

Once the skilled provider has a diagnosis, a treatment protocol can be prepared, at 104. The treatment protocol can include medicine, a rehabilitation regimen, support devices or a combination thereof. In one embodiment, the treatment protocol for a knee includes a hyaluronate injection into the intra-articular space of a knee, a physical rehabilitation regimen and a weight bearing support, such as a supporting knee brace. The hyaluronate injections can be delivered to the intra-articular space at a site of injection which has been determined to have tricompartmental flow.

Once the site of injection is determined, the hyaluronate composition including a high molecular weight hyaluronate can be injected into the intra-articular space. In this instance, medium to high molecular weight hyaluronate means hyaluronate with a molecular weight of greater than or equal to 500 kilo Daltons (kD). In one embodiment, the molecular weight can be between 500 kD to 10000 kD, such as between 500 kD to 6000 kD. In another embodiment, the molecular weight can be from 500 kD to 1700 kD, such as from 600 kD to 1100 kD. In further embodiments, the molecular weight can be greater than 700 kD, such as greater than 800 kD, greater than 900 kD or greater than 1000 kD. The hyaluronate can be a native form of hyaluronate or a conjugated form of hyaluronate. Further, the hyaluronate compositions used in the embodiments described herein may be entirely a specific weight, a specific weight range (such as from 700 kD to 1000 kD) or a combination of weight ranges. For example, the hyaluronate compositions may include from 0.4% to 0.8% w/v hyaluronate, wherein the hyaluronate includes both from 0.3% to 0.5% w/v of between 600 kD to 1100 kD hyaluronate and from 0.1% to 0.5% w/v of a low molecular weight hyaluronate (less than 600 kD) dissolved in a 0.9%-1.0% (physiological) saline solution. Examples of hyaluronate compositions which can be used in embodiments of the invention include SUPARTZ® available from Bioventus LLC located in Durham, N.C.

The joint can be supported using the weight bearing support before, during or after the other portions of the treatment protocol. In conjunction with hyaluronate injections and physical therapy, patients with moderate to severe osteoarthritis may benefit from the use of a weight bearing supports, such as an off the shelf or custom fitted unicompartmental unloading knee brace, to reduce pain and provide stability. These braces or other weight bearing supports have the ability to decompress or shift compressive knee joint forces from the degenerative area to healthy compartments in the knee. They can also provide ligamentous stability anterior/posterior and/or medial/laterally through structural support and local perception. Additionally, the weight bearing support can allow for increased activity which can provide pain relief through sensory stimulation. In one embodiment, the unloading knee bracing is designed to put three points of pressure on the femur. These points of pressure are believed to force the knee to bend away from the painful aspect of the knee. Thus, the weight bearing support transfers or “unloads” stress or pressure from a degenerated portion of the knee to a less-degenerated or healthy portion of the knee.

One or more rehabilitation routines can be provided to the patient. In one embodiment, the physical rehabilitation regimen can be a six to eight week physical therapy and rehabilitation program. The six to eight week physical therapy and rehabilitation program consists of therapeutic exercises and education designed to increase blood flow and strengthen muscles proximate to the joint. The therapeutic exercises can also improve overall physical function and reduce pain both at the joint and in related areas of the body.

The physical therapy algorithm is measurable, and functionally based towards addressing activities of daily living (ADLs) and comparing prior functional levels to current functional levels. The algorithm challenges the patient on multiple physiological levels, such as strength, cardiovascular, balance/proprioception and coordination. One to five therapy visits can be scheduled prior to the first injection to allow for baseline functional testing.

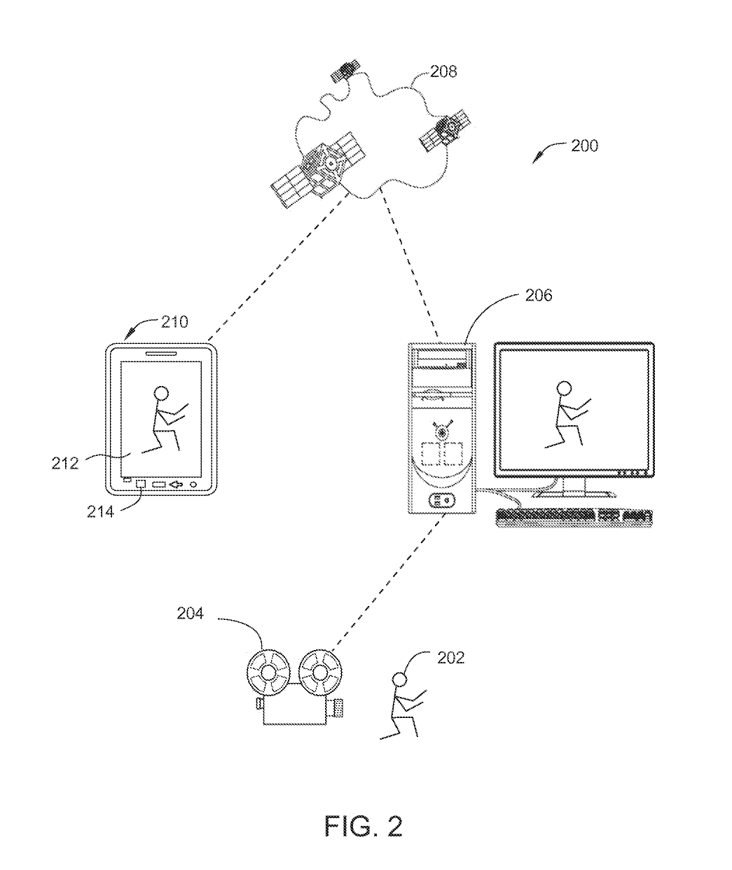

Once the treatment protocol is prepared, the treatment protocol can then be delivered to the patient, at 106. The treatment protocol can be delivered directly to the patient, such as through an office visit. Further, one or more portions of the treatment protocol can be delivered remotely, described more fully with reference to FIG. 2. The patient will then perform the treatment protocol including the rehabilitation regimen over the first period of time. The first period of time is the time over which the patient is receiving and performing the treatment protocol. This time period can be any time period length, such as days or months. The performance of the treatment protocol can include both guided portions, such as exercises performed in the office under the supervision of the skilled provider, and individual portions, such as performing a rehabilitation regimen at home as provided by the skilled provider.

Finally, the patient is reevaluated for one or more indicators of improvement, at 108. The patient is then reexamined by a skilled provider after the period of time. Indicators of improvement can include increased mobility, better quality of life or other subjective or objective measures. The skilled provider can use the indicators to adjust the treatment protocol.

Though exercise with a skilled provider creates more positive outcomes than individual non-guided rehabilitation regimen, there is a significant cost advantage to performing some of the rehabilitation without the skilled provider. Further, access to a skilled provider may be limited, such as in a region which has a limited number of skilled providers. As such, the patient recovers sooner and more completely by performing at least some of the treatment protocol, such as the rehabilitation regimen, remotely. To assure that the patient is performing the rehabilitation regimen appropriately, a visual rehabilitation regimen can be provided.

FIG. 2 depicts a system 200 for visual instruction delivery, according to one embodiment. Once the skilled provider has given the patient a diagnosis and created either the prehab protocol or the rehabilitation protocol, a visual instruction regimen is created to allow the patient to receive instruction and guidance at home. The visual instruction regimen includes one or more videos chosen or created to provide instruction on the performance of the rehabilitation protocol. The videos can be changed or adjusted to meet the needs of the patient. Further, the videos can complement the prehab instruction and/or the rehabilitation instruction received by the patient from the skilled provider or they can be used to provide instruction independent of the prehab instruction and/or the rehabilitation instruction from the skilled provider.

The system 200 can begin with the creation of the visual instruction regimen. An actor 202 receives instruction from a skilled provider, based on the rehabilitation protocol or prehab protocol. The actor 202 can be the patient, the skilled provider or a third party performing under the instruction of the skilled provider. The actor 202 then performs one or more activities following the skilled provider instruction. The activities can include knee bends, stretches, flexing and extending the leg or other activities which are suggested or included in the rehabilitation protocol or the prehab protocol. The actor 202 is in capture range of a video capture device 204 which captures video of the actor 202 performing the activities. The video capture device 204 can be a digital video camera, a still frame camera with video capture capability or other device which can capture video. Audio can be captured concurrently with the video, such as by recording the audio of the instruction being given to the actor, audio can be added later, such as by providing separate instruction from the skilled provider to the individual, or combinations thereof, such as recording the audio instruction with the actor and providing commentary which is dubbed in later.

The captured video is then transferred to a computing device 206. Shown here, the computing device 206 can be an electronic device, such as a personal computer, a smartphone, or a tablet. Though shown as one device, the computing device 206 can be one or more electronic devices acting in conjunction to perform the functions described herein. The video capture device 204 can transfer the captured video to the computing device 206 or a third party can act to transfer the captured video from the video capture device 204 to the computing device 206.

The computing device 206 includes a processor and memory. Processor serves to execute instructions for software that can be loaded into memory or other storage medium. The processor can be a number of processors, a multi-processor core, or some other type of processor, depending on the particular implementation. Further, the processor can be implemented using a number of heterogeneous processor systems in which a main processor is present with secondary processors on a single chip, such as a central processor with an integrated graphics processing unit. As another illustrative example, processor can be a symmetric multi-processor system containing multiple processors of the same type.

The memory and/or storage medium are accessible by processor, thereby enabling the processor to receive and execute instructions stored on the memory and/or on the storage medium. The memory can be, for example, a random access memory (RAM) or any other suitable volatile or non-volatile computer readable storage medium. In addition, the memory can be fixed or removable. The storage medium can take various forms, depending on the particular implementation. For example, the storage medium can contain one or more components or devices. For example, the storage medium can be a hard drive, a flash memory, an optical disk (either rewriteable or single write), a magnetic tape, or some combination of the above. The storage medium also can be fixed or removable. For example, a removable hard drive can be used as the storage medium.

One or more software modules are encoded in the storage medium and/or in the memory. The software modules can comprise one or more software programs or applications having computer program code or a set of instructions executed in processor. The computer program code can execute entirely on the computing device 206, partly on the computing device 206, partly on a remote computer or server (not shown) or entirely on the remote computer or server. In the latter scenario, the remote computer can be connected to computing device 206 through a network 208. The network 208 can be any type of network, including a local area network (LAN) or a wide area network (WAN), or a peer to peer connection. In one embodiment, the network 208 is the internet.

Once the captured video is accessible to the computing device 206, the computing device 206 can provide the captured video over the network 208. The captured video may be locally stored by the computing device 206.

The patient can connect to the computing device 206 through the network 208 using a second computing device 210 to remotely view the visual instruction regimen. The second computing device 210 includes components as described with reference to the computing device 206, such as a processor, memory and software modules. The remote device 210 has a display 212 and one or more input devices 214. The display 212 can be a touch responsive or stylus responsive display. In one embodiment, the remote device 210 is a tablet. The patient can use the remote device 210 to connect with the computing device 206. The remote device 210 can transmit and/or receive data to/from the computing device 206. The remote device 210 can be any device capable of communication with computing device 206, such as a desktop computer, a handheld/portable computer, smartphone, personal digital assistant (PDA), tablet computer (such as an iPad, manufactured by Apple, Inc. of Cupertino, Calif.) and/or any device that is capable of transmitting and receiving data to/from the computing device 206. The patient of remote device 210 can interact with the computing device 206 through an application executing on the remote device 210. This application provides a simple and intuitive patient interface that enables the patient to receive, review, and input data, information, and/or settings that relate to the captured video, prehab protocols or rehabilitation protocols. The application can receive input from the patient through one or more input devices 214, depicted here as a button. Upon receiving the appropriate input from the patient, the remote device 210 can receive a captured video which is displayed on the display 212. In an alternate arrangement, the patient can receive the captured video from the computing device 206 through a website and/or a web-based interface.

The remote device 210 displays the captured video either from the web-based interface or from the application, providing the patient the opportunity to access and perform the activities related to a prehab protocol or rehabilitation protocol without a visit to the skilled provider. Further, the captured video offers guidance to the patient who might otherwise be unclear on the performance of certain exercises, saving the patient both time and money.

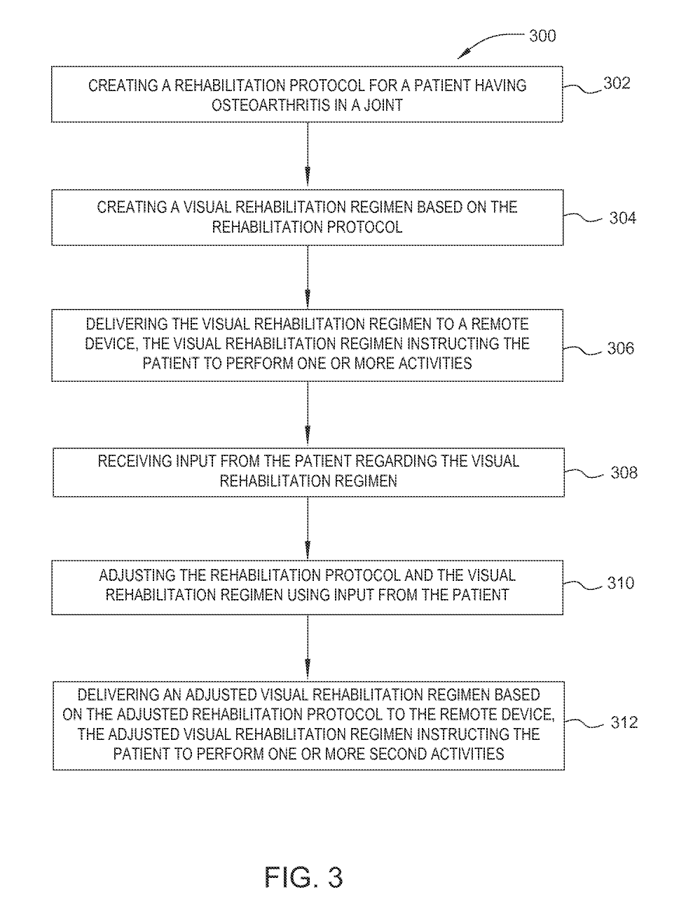

FIG. 3 depicts a flow diagram of a method 300 of rehabilitation, according to one embodiment. The method 300 includes creating a rehabilitation protocol for a patient having osteoarthritis in a joint, at 302; creating a visual rehabilitation regimen based on the rehabilitation protocol, at 304; delivering the visual rehabilitation regimen to a remote device, the visual rehabilitation regimen instructing the patient to perform the one or more activities, at 306; receiving input from the patient regarding the visual rehabilitation regimen, at 308; adjusting the rehabilitation protocol and the visual rehabilitation regimen using input from the patient, at 310; and delivering an adjusted visual rehabilitation regimen based on the adjusted rehabilitation protocol to the remote device, the adjusted visual rehabilitation regimen instructing the patient to perform one or more second activities, at 312. By delivering the rehabilitation remotely using one or more videos, the patient will be more compliant with the home portion of the rehabilitation protocol, receiving readily available guidance on the performance of the activities and be able to provide input on their health and development during each step of the rehabilitation.

The method 300 begins with creating a rehabilitation protocol for a patient having osteoarthritis in a joint, at 302. Before beginning the method of rehabilitation, the patient has been determined to have a condition which requires treatment from the skilled provider, such as osteoarthritis. The skilled provider will then create the rehabilitation protocol based on the condition of the patient and other related determinations. The rehabilitation protocol includes a description of the affected area, the level of degeneration or injury, types and categories of activities which are determined to be beneficial to the correct the degeneration or injury, developmental goals for the patient over a specific time frame and other information to assist in the current and future diagnosis and recovery of the patient. The rehabilitation protocol may also include a list of specific activities including days when the activities are to be performed, activities which are anticipated to be performed based on expected improvement/change and alternative activities based on possible deviance from the expected improvement/change.

Once the rehabilitation protocol is created, a visual rehabilitation regimen based on the rehabilitation protocol is created, at 304. The visual rehabilitation regimen is a live action video or performance of one or more activities for the rehabilitation protocol. The visual rehabilitation regimen can be a video recording of the interaction of the skilled provider and the patient in the skilled provider's office. In another embodiment, an actor can be recorded while performing the activities following the instruction of the skilled provider. In a further embodiment, the visual rehabilitation regimen is a prerecorded video including prerecorded instruction from a second skilled provider, which the skilled provider deems applicable to the patient's degeneration or injury. Here, the audio of the prerecorded video can either be left intact (e.g., including the instruction given by the second skilled provider) or the audio can be replaced by audio which is created for the patient by the skilled provider (e.g., audio which directs the patient on the performance of the activities included in the prerecorded video). In yet a further embodiment, the visual rehabilitation regimen is a live action video, such as a video created by telemedicine or other live action video which is delivered as a stream over a network.

Once the visual rehabilitation protocol is created, the visual rehabilitation regimen is then delivered to a remote device, at 306. The visual rehabilitation regimen can then be made available to an application or web site for viewing by a remote device, as described with reference to FIG. 2. The remote device can be a device as described above, such as a tablet. The visual rehabilitation regimen is then presented to the patient on the display of the remote device. One or more activities are represented in the visual rehabilitation regimen which provides instruction to the patient.

The patient, upon receiving the visual rehabilitation regimen, can perform the one or more activities. In one embodiment, the patient runs an application on the remote device which contacts the computing device controlled directly or indirectly by the skilled provider. The application then retrieves the visual rehabilitation protocol based on instructions received by the patient. The visual rehabilitation protocol is displayed by the remote device for the patient to view. The patient then performs the one or more activities based on the visual rehabilitation regimen. The activities may include knee lifts, walking, stretching, bends or other movements designed to strengthen or change an attribute of the affected area.

Input is then received from the patient regarding the visual rehabilitation regimen, at 308. Input is described as any communication received from the patient by the skilled provider. The input can be received as responses to a survey or questionnaire (e.g., visual analog scale, quality of life scale, Western Ontario and McMaster Universities Osteoarthritis Index (WOMAC), or others) or individualized questions related to the detected indicators. The input can be elicited by a specific call for information (e.g., the patient providing said input in response to a request for information), by a time frame for response (e.g., the patient providing said input every week without specific request) or by another fashion to receive input from the patient regarding current health or status. Further, the input can be provided to the skilled provider without prompting from the skilled provider, such as in relation to an adverse event (e.g., pain) or at the patient's discretion. In another embodiment, the input can be completely autonomous and not dependent on interaction from the patient, such as from a heart rate monitor or other fitness-related device.

The patient provides input to the skilled provider. The input can be provided through the remote device, such as through the application or web site. In another embodiment, the patient can provide the input by other known communication methods, such as over the phone, by mail, by fax or others. The input can be received directly by the skilled provider or it can be received by a third party. In another embodiment, input can be elicited by data collection devices, such as a heart rate monitor, which transmits data to the skilled provider for further analysis without patient interaction. The information can be transmitted largely in the same form or it can be transformed or analyzed prior to transmission. In another embodiment, the patient communicates with the skilled provider directly through a telemedicine link. The telemedicine link can be available on the website, the application or through another site or application available to the patient.

Using the received input from the patient, the rehabilitation protocol and the visual rehabilitation regimen can be adjusted, at 310. Some data, such as an indication that the patient is not achieving the goals established by the rehabilitation protocol, may inform the skilled provider that adjusting the rehabilitation protocol and/or the visual rehabilitation regimen is desirable. The skilled provider can then adjust the rehabilitation protocol and/or the visual rehabilitation regimen provided to the patient.

The rehabilitation protocol can be adjusted to indicate a new prognosis, further degeneration, ineffective activities or other criteria related to the patient as they progress through the visual rehabilitation regimen. The adjusted rehabilitation protocol provides an indication of changes or adjustments that the skilled provider can make in the visual rehabilitation regimen to benefit the patient. The adjusted visual rehabilitation regimen can include one or more adjusted videos of the one or more activities and one or more second activities based on the adjusted rehabilitation protocol. The adjustment to the visual rehabilitation regimen can include changing the prerecorded video list, changing the audio instruction on the prerecorded video, recording a new video with the patient receiving new instruction from the skilled provider, recording a new video with the actor receiving instruction from the skilled provider, or combinations thereof. The adjusted videos of the adjusted visual rehabilitation regimen can then either supplement the preexisting videos or replace the preexisting videos form the visual rehabilitation regimen.

Once the rehabilitation protocol and the visual rehabilitation regimen have been adjusted, the adjusted visual rehabilitation regimen can be delivered to the patient, at 312. The patient can access the adjusted visual rehabilitation regimen through the same methods as described with reference to the visual rehabilitation regimen, with reference to 306. The patient can then perform the one or more second activities based on the adjusted visual rehabilitation regimen.

The visual rehabilitation protocol can provide easy and immediate access to the information from the skilled provider simulating direct skilled provider interaction, thus reducing the costs of rehabilitation without reducing the benefits received by the patient. The rehabilitation protocol can employ the visual rehabilitation regimen as desired with consideration of patient progress. In one embodiment, the visual rehabilitation regimen is delivered every other day, with the patient meeting with the skilled provider on days between. In another embodiment, the visual rehabilitation regimen is used on alternating weeks, with the patient meeting with the skilled provider on other weeks.

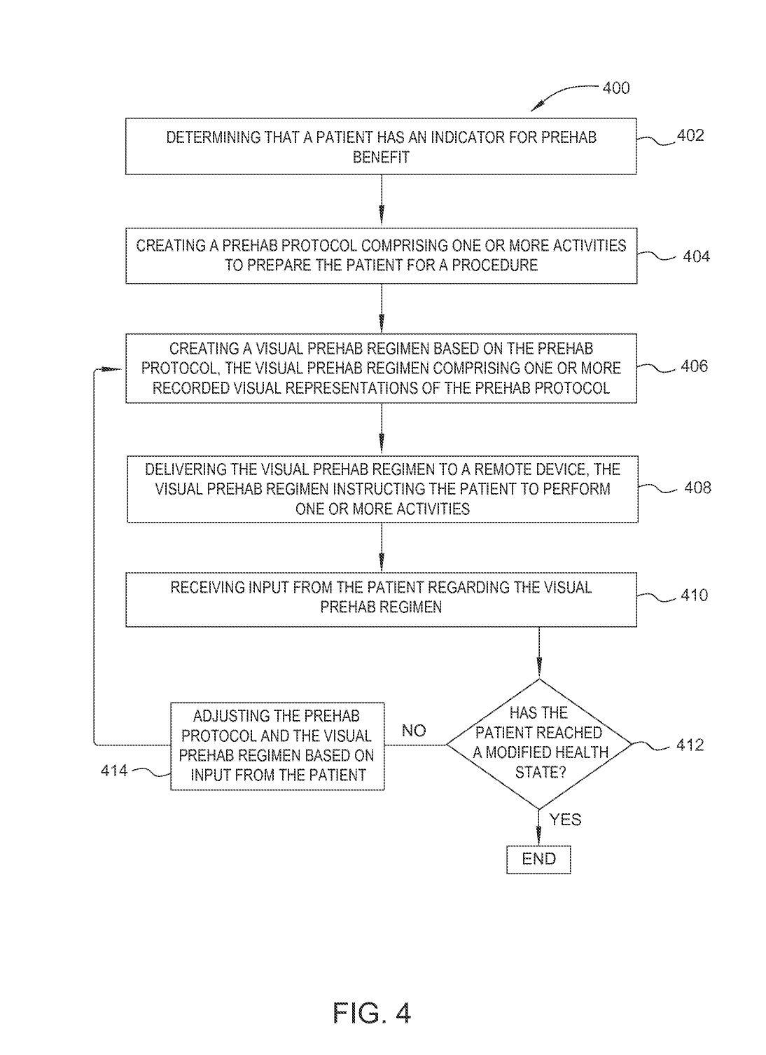

FIG. 4 depicts a flow diagram of a method 400 of prehab, according to one embodiment. The prehab protocol alongside the visual prehab regimen provides a cost effective way to help a patient prepare for a procedure or further rehabilitation while avoiding injury. The method 400 can include determining that a patient has an indicator for prehab benefit, at 402; creating a prehab protocol comprising one or more activities to prepare the patient for a procedure, at 404; creating a visual prehab regimen based on the prehab protocol, the visual prehab regimen comprising one or more recorded visual representations of the prehab protocol, at 406; delivering the visual prehab regimen to a remote device, the patient performing one or more activities based on the visual prehab regimen, at 408; eliciting input from the patient regarding the visual prehab regimen, the patient providing said input, at 410; adjusting the prehab protocol and the visual prehab regimen based on input from the patient, at 412; determining if the patient has reached a first health state at 414.

The method 400 can begin by determining that a patient has an indicator for prehab benefit, at 402. Prehab benefit can include the skilled provider determining if the patient has indicators of degeneration or injury, such as osteoarthritis in a joint. A patient can have one or more signs of degeneration or injury, such as pain in the knee. The patient can then contact a skilled provider, as described above, for analysis related to the one or more signs of degeneration or injury. This analysis can include visual analysis, subjective/objective questionnaires, or visualizations of the sight of injury, such as an ultrasound or fluoroscopic analysis. The analysis can lead to the discovery of an indicator of osteoarthritis, such as loss of flexibility in the joint, a grating sensation when the patient uses the joint, bone spurs forming around the joint, visible lesions in the articular cartilage or other indicators of osteoarthritis. In another embodiment, the indicator of prehab benefit can be an upcoming surgical procedure, such as a knee replacement. In this case, the prehab benefit is defined by the existence of the procedure and no further analysis by the skilled provider is needed to determine the prehab benefit.

Once prehab benefit has been determined, a prehab protocol can be created to prepare the patient for the procedure, at 404. The skilled provider will then create the prehab protocol based on the procedure, the condition of the patient, risk factors and other considerations. The prehab protocol includes a description of the affected area, the procedure being prepared for, the cause for the procedure, types and categories of activities which are determined to be beneficial from preparation of the affected site, developmental goals for the patient over a specific time frame and other information to assist in the current and future diagnosis and recovery of the patient. The prehab protocol may also include a list of specific activities including days when the activities are to be performed, activities which are anticipated to be performed based on expected improvement/change and alternative activities based on possible deviance from the expected improvement/change. The procedure can include rehabilitation, an exercise plan, a surgical procedure or other event which might require prehab preparation to avoid injury.

Once the prehab protocol is created, a visual prehab regimen based on the prehab protocol is created, at 406. The visual prehab regimen is a live action video or performance of one or more activities for the prehab protocol. The visual prehab regimen can be substantially similar in design to the visual rehabilitation regimen, described with reference to FIG. 3.

Once the visual prehab protocol is created, the visual prehab regimen is then delivered to a remote device, at 408. The visual prehab regimen can then be made available to an application or web site for viewing by a remote device, as described with reference to FIG. 2. The remote device can be a device as described above, such as a tablet. The visual prehab regimen is then presented to the patient on the display of the remote device. The visual prehab regimen can be received by the remote device in a substantially similar fashion as the visual rehabilitation regimen, described with reference to FIG. 3.

Input is then received from the patient regarding the visual prehab regimen, at 410. Input is described as any communication received from the patient by the skilled provider. The input for the visual prehab regimen can be elicited from the patient by the skilled provider, provided from the patient to the skilled provider and received by the skilled provider from the patient in a substantially similar way as described above, with reference to FIG. 3.

Then the skilled provider can determine if the patient have achieved a modified health state, at 412. The modified health state is an intermediate health state which indicates that the patient has reached either a state of maximum expected benefit from the prehab protocol or that the patient can safely undergo the procedure. The modified health state may be a certain level of mobility, a percentile increase in blood flow to a specific region of the body or some other desired physiological effect which is achievable by a prehab protocol. Once the modified health state is achieved, the patient can then perform or undergo the subsequent procedure.

If the modified health state is not achieved, the prehab protocol and the visual rehabilitation protocol can be adjusted using the received input, at 414. Information received from the input may inform the skilled provider that changing or adjusting the prehab protocol and/or the visual prehab regimen is desirable. The skilled provider can then adjust the prehab protocol and/or the visual prehab regimen provided to the patient.

The prehab protocol can be adjusted to indicate a new prognosis, new procedures, further degeneration, ineffective activities or other criteria related to the patient as they progress through the visual prehab regimen. The adjusted prehab protocol provides an indication of changes or adjustments that the skilled provider can make in the visual prehab regimen to benefit the patient. The adjusted visual prehab regimen can include one or more adjusted recorded visual representations of the one or more activities and one or more second activities based on the adjusted prehab protocol. The adjustment to the visual prehab regimen can include changing a prerecorded video list, changing the audio instruction on a prerecorded video, recording a new video with the patient receiving new instruction from the skilled provider, recording a new video with an actor receiving instruction from the skilled provider, or combinations thereof. The adjusted videos of the adjusted visual prehab regimen can then either supplement the preexisting videos or replace the preexisting videos from the visual prehab regimen. At this point, the method will be repeated from 406 to 412 until the modified health state is achieved.

By performing a prehab protocol including a visual prehab regimen, the patient can achieve the benefits of an office visit with a skilled provider at a lower cost and inconvenience. Further, the visual prehab regimen can increase compliance and by the patient and allow the patient to perform the requested activities with more flexibility than an office visit would provide.

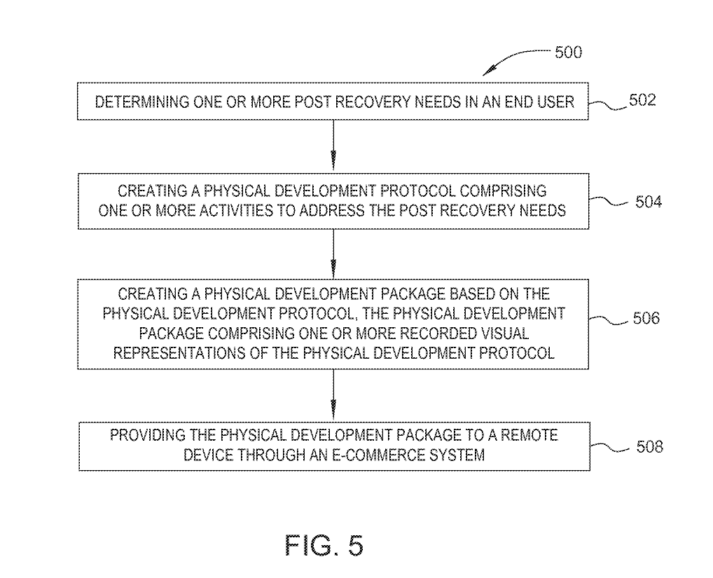

FIG. 5 depicts a flow diagram of a method 500 of delivery of physical development packages, according to one embodiment. A physical development package is a combination of a physical development protocol, physical development regimen or both. The physical development packages are delivered through the same platform as the prehab and rehabilitation programs, or through similar platforms. In one example, the physical development protocol can be delivered from the provider to the end user or the end user through an e-commerce site. The physical development packages can be transferred to the end user in separate increments (e.g., a la carte).

The method 500 can include a provider determining one or more post recovery needs in an end user, at 502; creating a physical development protocol comprising one or more activities to address the post recovery need, at 504; creating a physical development package based on the physical development protocol, the physical development package comprising one or more recorded visual representations of the physical development protocol, at 506; providing the physical development package to a remote device through an e-commerce system, at 508.

The method 500 can begin by the provider determining that an end user has one or more post recovery needs, at 502. Post recovery needs are developmental needs that develop after the initial disease state is either appropriately managed such that further deterioration is not occurring or the original disease state has been cured. Post recovery needs can be related to recurrence of the original disease state or the occurrence of a secondary disease state. The original disease state is that disease state from which the end user recovered. The secondary disease state is a disease state which can occur post recovery and has some relation to the original disease state. In one example, the original disease is osteoarthritis of the knee and the secondary disease is hypertension, such as due to a more sedentary lifestyle. This determination can include visual analysis, subjective/objective questionnaires, medical history review or medical device visualization of the end user, such as an ultrasound or fluoroscopic analysis. In another embodiment, one or more automated detection devices can provide information to the provider, such as one or more cameras detecting an abnormal gait. The cameras, infrared sensors, or other automated detection device can provide a recording which can detect the developmental need either heuristically or based on previously accumulated data from either the end user or other users.

Once post recovery need has been determined, creating a physical development protocol comprising one or more activities to address the post recovery need, at 504. The provider will then create the physical development protocol based on the condition of the end user, risk factors and other considerations. The physical development protocol can include a description of the affected area, the treatment as related to the original disease state and the secondary disease state, types and categories of activities which are determined to be beneficial, developmental goals for the end user over a specific time frame and other information to assist in the current and future diagnosis and recovery of the end user. The physical development protocol may also include a list of specific activities including days when the activities are to be performed, activities which are anticipated to be performed based on expected improvement/change and alternative activities based on possible deviance from the expected improvement/change. The procedure can include rehabilitation, an exercise plan, dietary adjustment or others changes which are expected to benefit the physical development of the end user.

Once the physical development protocol is created, a physical development package based on the physical development protocol is created, at 506. The physical development package is a live action video or performance of one or more activities for the physical development protocol. Further, the physical development package can be a combination of representations from more than one physical development protocol. The physical development package can include one or more components of the visual rehabilitation regimen, described with reference to FIG. 3. The physical development package can further include medical devices, such as braces, exercise equipment, such as weights, or nutritional supplements,

Once the physical development package is created, the physical development package is then delivered to a remote device through an e-commerce system, at 508. The physical development package can be made available to an application or web site for viewing by a remote device, as described with reference to FIG. 2. The remote device can be a device as described above, such as a tablet.

The e-commerce system is a system for the purchase and delivery of one or more components of the physical development package. The physical components of the e-commerce system include an end user computer, such as the computing device 206. The computing device 206 connected with the second computing device 210, which provides information regarding the e-commerce system. The e-commerce platform can be downloaded locally and installed to the computing device 206 or is can be viewed from the computing device 206 while being maintained on the second computing device 210.

The software components of the e-commerce system include an e-commerce platform. The e-commerce platform provides at least a display of available components of the physical development package for purchase and a purchasing mechanism of purchasing each component. In one embodiment, the physical development package includes a visual display including independent components of the physical development package. The visual display separates core components of the physical development package from optional components. Core components, as used herein, indicates components which form the basis of the package and provide a core benefit to be achieved. Core components can include an exercise routine for the purpose of increasing cardiovascular health as related to a sedentary lifestyle. Optional components are components which provide further benefit and enhance the effects of a core component. Examples of optional components include dietary regiments, supplements, or others.

In another embodiment of the e-commerce platform, the physical development packages can be a tiered system where multiple packages from the same treatment are presented, starting with a basic package and expanding into advanced packages or premium packages. Components such as exercise equipment, routines, training, and telemedicine components could be added on or removed to minimize costs while providing the desired level of care to the end user. Further components can include direct connect with non-physician providers, such as a provider that is a naturopath, podiatrist, chiropractor, etc. can have access to telemedicine with the end user.

After the selection is made, the physical development package is presented to the end user on the display of the remote device. The physical development package can be received by the remote device in a substantially similar fashion as the visual rehabilitation regimen, described with reference to FIG. 3.

In a further embodiment, a method of rehabilitation can include delivering a prehab protocol, the prehab protocol comprising one or more activities to prepare the patient for a replacement of a joint. The joint of the patient can then be replaced. A rehabilitation protocol can then be created for a patient after the joint is replaced, the rehabilitation protocol comprising one or more activities established for rehabilitation of the patient. A live action video can then be created based on the rehabilitation protocol, the live action video comprising one or more recorded visual representations of the rehabilitation protocol. The live action video can then be delivered to a remote device, the live action video instructing the patient to perform the one or more activities. Input can then be received, if appropriate, from the patient regarding the activities performed in conjunction with the live action video. The rehabilitation protocol can then be adjusted using input from the patient. An adjusted live action video can then be delivered to the remote device, the patient performing one or more second activities based on the adjusted live action video.

The method of rehabilitation can further include the remote device being a smartphone or a computer. The method of rehabilitation can further include receiving a prehab protocol comprising one or more activities to prepare for rehabilitation.

The method of rehabilitation can further include receiving a visual prehab system, the visual prehab system including receiving a visual prehab regimen based on the prehab protocol, the visual prehab regimen comprising one or more recorded visual representations of the prehab protocol. One or more activities can then be performed based on the visual prehab regimen, the visual prehab regimen being received by a remote device, the visual prehab regimen having instructions to perform one or more activities based on the visual prehab regimen. Further input can then be provided to the skilled provider regarding the visual prehab regimen. Adjustments to the visual prehab regimen and the prehab protocol can the be received from the skilled provider based on the input sent to the skilled provider. The visual prehab system can be further performed until reaching a modified health state. A rehabilitation protocol can then be performed once the patient reaches a modified health state, the rehabilitation protocol including one or more activities established for rehabilitation.

The method of rehabilitation can further include receiving a visual rehabilitation regimen based on the rehabilitation protocol, the visual rehabilitation regimen comprising one or more recorded visual representations of the rehabilitation protocol. The visual rehabilitation regimen can then be received through a remote device. The one or more activities can then be performed based on the visual rehabilitation regimen. The patient or a device can then send input to the skilled provider regarding the visual rehabilitation regimen. An adjusted rehabilitation protocol and an adjusted visual rehabilitation regimen can then be received by the patient based on the input.

The method of rehabilitation can further include the skilled provider performing the following steps prior to the patient receiving the prehab protocol: determining a site of injection in a knee of a patient using flow determination imaging; injecting a volume of a medium to high molecular weight hyaluronate composition into the selected site of injection, wherein the high molecular weight hyaluronate composition flows tricompartmentally; and supporting the knee using a weight bearing support at least during one of the one or more rehabilitation routines.

The method of rehabilitation can further include the input comprising completion of a visual analog scale, completion of a quality of life scale, completion of the Western Ontario and McMaster Universities Osteoarthritis Index (WOMAC) or combinations thereof.

The method of rehabilitation can further include the quality of life scale being finished after the patient performs the one or more activities. The method of rehabilitation can further include the input being sent to the skilled provider through the remote device. The method of rehabilitation can further include using telemedicine in conjunction with receiving input, receiving the prehab protocol or receiving the visual prehab regimen. The method of rehabilitation can further include patient performance of the prehab protocol being monitored by patient feedback. The method of rehabilitation can further include determining whether a patient has an indicator of osteoarthritis in a joint.

In another embodiment, a method of rehabilitation can include receiving a rehabilitation protocol for osteoarthritis in a joint, the rehabilitation protocol comprising one or more activities established for rehabilitation by a skilled provider. A visual rehabilitation regimen can be received using a remote device, the visual rehabilitation regimen being based on the rehabilitation protocol and comprising one or more recorded visual representations of the rehabilitation protocol. The one or more activities can then be performed based on the visual rehabilitation regimen. Input can then be provided to the skilled provider regarding the visual rehabilitation regimen. An adjusted visual rehabilitation regimen based on the adjusted rehabilitation protocol can then be delivered to the remote device, the adjusted rehabilitation regimen having instructions to perform one or more second activities based on the adjusted visual rehabilitation regimen.

The method of rehabilitation can further include the skilled provider performing the following steps prior to the patient receiving the rehabilitation protocol: determining a site of injection in a knee of a patient using flow determination imaging; injecting a volume of a medium to high molecular weight hyaluronate composition into the selected site of injection, wherein the high molecular weight hyaluronate composition flows tricompartmentally; and supporting the knee using a weight bearing support at least during one of the one or more rehabilitation routines.

The method of rehabilitation can further include the input being received by the skilled provider through the remote device.

The method of rehabilitation can further include using telemedicine in conjunction with receiving input, receiving the rehabilitation protocol or receiving the visual rehabilitation regimen.

The method of rehabilitation can further include patient performance of the rehabilitation protocol being monitored by patient feedback.

### CONCLUSION

Embodiments described herein relate to methods of rehabilitating a knee joint. As of 2005, OA affects approximately 13.9% of the U.S. population over the age of 25, and this proportion is steadily increasing. There is no known cure for OA, thus patients rely largely on various interventions to both improve outcomes and quality of life. Embodiments described herein disclose methods of delivering prehab or rehabilitation to the knee using a visual prehab regimen or a visual rehabilitation regimen showing the activities from the prehab or rehabilitation protocol. By providing recorded visual representations of the activities, the patient can receive instruction from the skilled provider at home or in other locations, enabling the patient to be more compliant with the skilled provider instructions. Further, the patient will be receiving the instruction at a lower cost while achieving optimal results. The patient can further provide input or feedback based on their progress through the prehab protocol or rehabilitation protocol as delivered through the videos. This feedback can then be used to adjust the prehab protocol, the visual prehab regimen, the rehabilitation protocol or the visual rehabilitation regimen, as appropriate.

While the foregoing is directed to embodiments of the present invention, other and further embodiments of the invention may be devised without departing from the basic scope thereof, and the scope thereof is determined by the claims that follow.

What is claimed is:

1. A method of rehabilitation, comprising:
creating a prehab protocol comprising one or more activities to prepare a patient for rehabilitation;
delivering a visual prehab system to the patient, the visual prehab system comprising:
creating a visual prehab regimen based on the prehab protocol, the visual prehab regimen comprising one or more recorded visual representations of the prehab protocol;
delivering the visual prehab regimen to a remote device, the visual prehab regimen instructing the patient to perform one or more activities based on the visual prehab regimen;
receiving input from the patient regarding the visual prehab regimen; and
adjusting the visual prehab regimen and the prehab protocol based on input from the patient;
repeating the visual prehab system until the patient has reached a modified health state; and
providing a rehabilitation protocol to the patient at the modified health state, the rehabilitation protocol comprising one or more activities established for rehabilitation of the patient.

2. The method of claim 1, further comprising:
creating a visual rehabilitation regimen based on the rehabilitation protocol, the visual rehabilitation regimen comprising one or more recorded visual representations of the rehabilitation protocol;
delivering the visual rehabilitation regimen to a remote device instructing the patient to perform the one or more activities based on the visual rehabilitation regimen;
receiving input from the patient regarding the visual rehabilitation regimen; and
adjusting the rehabilitation protocol and the visual rehabilitation regimen using input from the patient.

3. The method of claim 1, further comprising performing the following steps prior to providing the rehabilitation protocol:
determining a site of injection in a knee of a patient using flow determination imaging;
injecting a volume of a medium to high molecular weight hyaluronate composition into the selected site of injection, wherein the high molecular weight hyaluronate composition flows tricompartmentally; and
supporting the knee using a weight bearing support at least during one of the one or more rehabilitation routines.

4. The method of claim 1, wherein the remote device is a smartphone or a computer.

5. The method of claim 1, wherein the input comprises completion of a visual analog scale, completion of a quality of life scale, completion of the Western Ontario and McMaster Universities Osteoarthritis Index (WOMAC) or combinations thereof.

6. The method of claim 5, wherein the input is the quality of life scale.

7. The method of claim 1, wherein the input is received by the skilled provider through the remote device.

8. The method of claim 1, further comprising using telemedicine in conjunction with receiving input, adjusting the prehab protocol or adjusting the visual prehab regimen.

9. The method of claim 1, wherein patient performance of the prehab protocol is monitored by patient feedback.

10. The method of claim 1, further comprising determining that a patient has an indicator of osteoarthritis in a joint.

11. A method of rehabilitation, comprising:
creating a rehabilitation protocol for a patient having osteoarthritis in a joint, the rehabilitation protocol comprising one or more activities established for rehabilitation of the patient by a skilled provider;
creating a visual rehabilitation regimen based on the rehabilitation protocol, the visual rehabilitation regimen comprising one or more recorded visual representations of the rehabilitation protocol;
delivering the visual rehabilitation regimen to a remote device, the visual rehabilitation regimen instructing the patient to perform the one or more activities based on the visual rehabilitation regimen;
receiving input from the patient regarding the visual rehabilitation regimen;
adjusting the rehabilitation protocol and the visual rehabilitation regimen using input from the patient;
delivering an adjusted visual rehabilitation regimen based on the adjusted rehabilitation protocol to the remote device, the adjusted rehabilitation regimen instructing the patient to perform one or more second activities based on the adjusted visual rehabilitation regimen;
monitoring the patient during the performance of the rehabilitation protocol and the adjusted rehabilitation protocol for a replacement indicator; and
upon detecting a replacement indicator, delivering a prehab regimen, the prehab regimen comprising one or more activities to prepare the patient for replacement of a joint.

12. The method of claim 11, further comprising performing the following steps prior to creating the visual rehabilitation regimen:
determining a site of injection in a knee of a patient using flow determination imaging;
injecting a volume of a medium to high molecular weight hyaluronate composition into the selected site of injection, wherein the high molecular weight hyaluronate composition flows tricompartmentally; and
supporting the knee using a weight bearing support at least during one of the one or more rehabilitation routines.

13. The method of claim 11, wherein the remote device is a smartphone or a computer.

14. The method of claim 11, further comprising replacing the joint after delivering the prehab regimen.

15. The method of claim 11, wherein the input comprises completion of a visual analog scale, completion of a quality of life scale, completion of the Western Ontario and McMaster Universities Osteoarthritis Index (WOMAC) or combinations thereof.

16. The method of claim 15, wherein the quality of life scale is finished after the patient performs the one or more activities.

17. The method of claim 11, wherein the input is received by the skilled provider through the remote device.

18. The method of claim 11, further comprising using telemedicine in conjunction with receiving input, adjusting the rehabilitation protocol or adjusting the visual rehabilitation regimen.

19. The method of claim 11, wherein patient performance of the rehabilitation protocol is monitored by patient feedback.

20. A method of rehabilitation, comprising:
delivering a prehab protocol, the prehab protocol comprising one or more activities to prepare the patient for a replacement of a joint;
replacing the joint of the patient;
creating a rehabilitation protocol for a patient after the joint is replaced, the rehabilitation protocol comprising one or more activities established for rehabilitation of the patient;
creating a live action video based on the rehabilitation protocol, the live action video comprising one or more recorded visual representations of the rehabilitation protocol;
delivering the live action video to a remote device, the live action video instructing the patient to perform the one or more activities;
receiving input from the patient regarding the activities performed in conjunction with the live action video;
adjusting the rehabilitation protocol using input from the patient; and
delivering an adjusted live action video to the remote device, the patient performing one or more second activities based on the adjusted live action video.
